(19) United States
(12) Patent Application Publication
(10) Pub. No.: US 2015/0025732 A1
(43) Pub. Date: Jan. 22, 2015

(54) APPARATUS AND METHOD FOR CONTROLLING AUTOMATIC PARKING

(71) Applicant: ELECTRONICS AND TELECOMMUNICATIONS RESEARCH INSTITUTE, Daejeon-city (KR)

(72) Inventors: Kyoungwook MIN, Sejong (KR); Jeongdan CHOI, Daejeon (KR)

(73) Assignee: ELECTRONICS AND TELECOMMUNICATIONS RESEARCH INSTITUTE, Daejeon-city (KR)

(21) Appl. No.: 14/320,387

(22) Filed: Jun. 30, 2014

(30) Foreign Application Priority Data
Jul. 17, 2013 (KR) 10-2013-0083894

(51) Int. Cl. B62D 15/02

(52) U.S. Cl. CPC B62D 15/0285
USPC 701/23

(57) ABSTRACT

An automatic parking control apparatus and method are disclosed. The automatic parking control apparatus includes a selection unit, a processing unit, and a control unit. The selection unit selects a parking slot within a parking map received through a parking map reception unit. The processing unit computes a base point at which a vehicle is parallel to both sides of the selected parking slot when the vehicle enters the selected parking slot and a destination point at which automatic parking is completed, computes a start point and a cross point based on the base point, and establishes an automatic parking path including a plurality of sublines using the start point, the cross point, the base point and the destination point. The control unit controls the automatic parking so that the vehicle is parked along the automatic parking path.

### CROSS REFERENCE TO RELATED APPLICATION

This application claims the benefit of Korean Patent Application No. 10-2013-0083894, filed on Jul. 17, 2013, which is hereby incorporated by reference in its entirety into this application.

### BACKGROUND OF THE INVENTION

1. Technical Field

The present invention relates generally to an apparatus and method for controlling the automatic parking of a vehicle and, more particularly, to an apparatus and method for automatically parking a vehicle in at least one of modes including parallel parking, reverse parking and forward parking.

2. Description of the Related Art

Currently, automatic driving technology and automatic parking technology for a vehicle have been researched. Conventional automatic parking technology is designed to assist a driver in parking his or her vehicle. The operation of the conventional automatic parking technology is performed as follows.

First, a process of recognizing a parking space is performed using sensors capable of detecting an area in front of or behind a vehicle. In this recognition process, other vehicles must be present in parking slots beside a parking slot where the vehicle is to be parked.

Thereafter, a process of generating a parking trajectory across the recognized parking area using a parking assistant system, for example, a smart parking assist system (SPAS), is performed.

Thereafter, in order to follow the parking trajectory, the steering wheel of the vehicle is automatically manipulated, and a driver shifts gears and manipulates the accelerator and brake of the vehicle. That is, in the conventional automatic parking technology, only steering is automatically controlled, and driving, braking and gear shifting are performed by a driver. Furthermore, as described in connection with the recognition process, vehicles must be present in both side parking slots.

In this regard, Korean Patent Application Publication No. 2013-0045284 discloses a method and apparatus for assisting the parking of a motor vehicle.

### SUMMARY OF THE INVENTION

Accordingly, the present invention has been made keeping in mind the above problems occurring in the conventional art, and an object of the present invention is to provide an apparatus and method for controlling the automatic parking of a vehicle so that the vehicle is parked within a parking slot intended by a driver.

Another object of the present invention is to provide an apparatus and method that are capable of automatically performing parking without requiring a need for vehicles to be present in both side parking slots and a need for a driver to perform driving, braking and gear shifting, unlike in a conventional automatic parking method.

In accordance with an aspect of the present invention, there is provided an automatic parking control apparatus, including a selection unit configured to select a parking slot within a parking map received through a parking map reception unit; a processing unit configured to compute a base point at which a vehicle is parallel to both sides of the selected parking slot when the vehicle enters the selected parking slot and a destination point at which automatic parking is completed, to compute a start point and a cross point based on the base point, and to establish an automatic parking path including a plurality of sublines using the start point, the cross point, the base point and the destination point; and a control unit configured to control the automatic parking so that the vehicle is parked along the automatic parking path.

The processing unit may compute a first minimum radius circle based on a maximum steering angle of the vehicle at the base point.

The processing unit may further compute a second minimum radius circle that is parallel to the tops of the parking slots, comes into contact with a drive line, that is, an entry line of the vehicle, and the first minimum radius circle, and is formed based on the maximum steering angle of the vehicle.

The start point may be a point at which the drive line comes into contact with the second minimum radius circle; and the cross point may be a point at which the first minimum radius circle comes into contact with the second minimum radius circle.

The control unit starts the automatic parking at a point within a predetermined threshold from the start point.

The control unit may permit the vehicle to move to a subsequent subline if the distance between a last point of one subline and a stop point of the vehicle is equal to or shorter than the predetermined threshold during the automatic parking of the vehicle along to the subline.

The control unit may correct the second minimum radius circle into a second corrected circle that is vertical to a heading angle of the vehicle and comes into contact with the first minimum radius circle if, when the vehicle is stopped, the distance between the start point and the stop point of the vehicle exceeds zero and is equal to or shorter than the predetermined threshold, and may then move the vehicle from the stop point to a corrected cross point that comes into contact with the second corrected circle and the first minimum radius circle.

The control unit may correct the first minimum radius circle into a first corrected circle that is vertical to the heading angle of the vehicle, comes into contact with the second corrected circle, and comes into contact with a base line that connects the base point and the destination point if, when the vehicle is stopped, an error in the distance between the corrected cross point and the stop point of the vehicle exceeds zero and is equal to or shorter than the predetermined threshold, and may then move the vehicle from the stop point to a corrected base point that comes into contact with the first corrected circle and the base line.

The control unit may correct the mechanical error steering angle of the vehicle using a steering error table stored in a parking map storage unit.

In accordance with another aspect of the present invention, there is provided an automatic parking control method, including selecting, by a selection unit, a parking slot within a parking map received through a parking map reception unit; computing, by a processing unit, a base point at which a vehicle is parallel to both sides of the selected parking slot when the vehicle enters the selected parking slot and a destination point at which automatic parking is completed; computing, by the processing unit, a start point and a cross point based on the base point; establishing, by the processing unit, an automatic parking path including a plurality of sublines using the start point, the cross point, the base point and the destination point; and controlling, by a control unit, the automatic parking so that the vehicle is parked along the automatic parking path.

Computing the start point and the cross point may include computing a first minimum radius circle based on a maximum steering angle of the vehicle at the base point.

Computing the start point and the cross point may include further computing a second minimum radius circle that is parallel to the tops of the parking slots, comes into contact with a drive line, that is, an entry line of the vehicle, and the first minimum radius circle, and is formed based on the maximum steering angle of the vehicle.

The start point may be a point at which the drive line comes into contact with the second minimum radius circle; and the cross point may be a point at which the first minimum radius circle comes into contact with the second minimum radius circle.

Controlling the automatic parking may include starting the automatic parking at a point within a predetermined threshold from the start point.

Controlling the automatic parking may include permitting the vehicle to move to a subsequent subline when the distance between a last point of one subline and a stop point of the vehicle is equal to or shorter than the predetermined threshold during the automatic parking of the vehicle along the one subline.

Controlling the automatic parking may include correcting the second minimum radius circle into a second corrected circle that is vertical to a heading angle of the vehicle and comes into contact with the first minimum radius circle if, when the vehicle is stopped, the distance between the start point and the stop point of the vehicle exceeds zero and is equal to or shorter than the predetermined threshold, and then moving the vehicle from the stop point to a corrected cross point that comes into contact with the second corrected circle and the first minimum radius circle.

Controlling the automatic parking may include correcting the first minimum radius circle into a first corrected circle that is vertical to the heading angle of the vehicle, comes into contact with the second corrected circle, and comes into contact with a base line that connects the base point and the destination point if, when the vehicle is stopped, an error in the distance between the corrected cross point and the stop point of the vehicle exceeds zero and is equal to or shorter than the predetermined threshold, and then moving the vehicle from the stop point to a corrected base point that comes into contact with the first corrected circle and the base line.

Controlling the automatic parking may include correcting the mechanical error steering angle of the vehicle using a steering error table stored in a parking map storage unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an automatic parking control apparatus according to an embodiment of the present invention;

FIG. 2 illustrates an example of a method of generating a steering error table using the automatic parking control apparatus according to an embodiment of the present invention;

FIG. 3 illustrates the steering error table in the example of FIG. 2;

FIG. 4 is a diagram illustrating an example of a reverse right-angle parking method of a vehicle using the automatic parking control apparatus of the present invention;

FIG. 5 is a diagram illustrating an example of a method of the forward right-angle parking of a vehicle using the automatic parking control apparatus of the present invention;

FIG. 6 is a diagram illustrating an example of a method of the parallel parking of a vehicle using the automatic parking control apparatus of the present invention;

FIGS. 7 and 8 are diagrams illustrating examples in which a subline is corrected using a corrected circle in connection with the example of the reverse right-angle parking method of FIG. 4;

FIG. 9 is a flowchart illustrating an automatic parking control method according to an embodiment of the present invention;

FIG. 10 is a detailed flowchart illustrating automatic parking included in an automatic parking control method according to an embodiment of the present invention;

FIG. 11 is a flowchart illustrating a process of correcting a subline using a corrected circle if necessary through the comparison of the distance between a start point and the stop point of a vehicle; and

FIG. 12 is a flowchart illustrating a process of correcting a subline using a corrected circle if necessary through the comparison of the distance between a cross point and the stop point of a vehicle.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

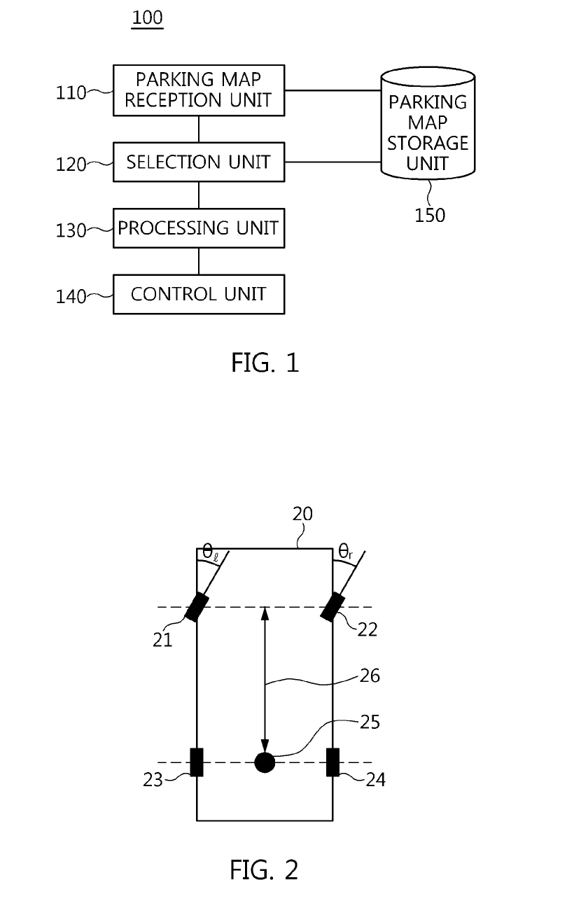

An automatic parking control apparatus 100 according to an embodiment of the present invention is described below with reference to FIG. 1. FIG. 1 is a block diagram of the automatic parking control apparatus 100 according to this embodiment of the present invention. The automatic parking control apparatus 100 according to this embodiment of the present invention includes a parking map reception unit 110, a selection unit 120, a processing unit 130, a control unit 140, and a parking map storage unit 150. The components are described in detail below.

The parking map reception unit 110 functions to receive a parking map corresponding to the current location of a vehicle. For this purpose, the parking map reception unit 110 may first track the current location of the vehicle using a location measurement device, such as a Global Positioning System (GPS). Furthermore, the parking map reception unit 110 may obtain the heading angle of the vehicle via such a location measurement device. Once the current location and heading angle of the vehicle have been obtained through the location measurement device as described above, the parking map reception unit 110 may receive the parking map corresponding to the current location of the vehicle from an external server or a separate parking map storage unit 150, and may display the parking map to a driver through an additional display device.

The selection unit 120 functions to selects a parking slot within the parking map received by the parking map reception unit 110. For example, the parking slot may be determined in response to a driver's selection, or an empty parking slot may be selected from among parking slots present on the parking map.

Furthermore, a driver may select a parking mode via the selection unit 120. In this case, the parking mode may include forward right-angle parking, reverse right-angle parking, and parallel parking. If the driver's selection of the parking mode is not given, the selection unit 120 may automatically select a parking mode that is most suitable for the selected parking slot.

The processing unit 130 functions to establish an automatic parking path along which the vehicle will be parked in the selected parking slot. For this purpose, the processing unit 130 first computes a point at which the vehicle will stop in order to perform forward driving or reverse driving and change a steering angle when the vehicle enters the selected parking slot in the parking mode selected by the driver. In this case, the stop point basically includes a start point, a cross point, a base point, and a destination point. A point that is described throughout the specification corresponds to the central point of the rear axle of the vehicle, that is, the central point of the rear wheel axle of the vehicle.

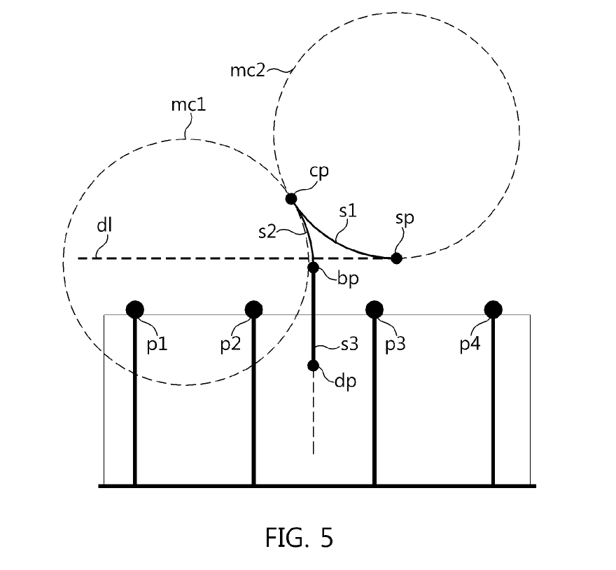

The base point is a point at which the vehicle becomes parallel to both sides of the selected parking slot when the vehicle enters the selected parking slot. Furthermore, the destination point is a point at which the automatic parking of the vehicle is completed. Furthermore, the start point is a point at which the vehicle initiates the automatic parking. Furthermore, the cross point is a point at which the vehicle stops in order to change its moving direction, for example, to switch between forward driving and forward driving after starting from a start point. In this case, a method of computing the start point and the cross point is described in detail later with reference to FIG. 4, and thus a description thereof is omitted for clarity of description.

As described above, the processing unit 130 may compute the start point, the cross point, the base point and the destination point, and may establish the automatic parking path by connecting the points. That is, the automatic parking path may include a first subline that connects the start point and the cross point, a second subline that connects the cross point and the base point, and a third subline that connects the base point and the destination point. In this case, it is to be understood that the number of sublines may vary depending on the circumstance.

The control unit 140 functions to control the automatic parking of the vehicle based on the points and the automatic parking path generated by the processing unit 130. That is, the control unit 140 functions to correctly park the vehicle by controlling the steering angle, gear shift, moving direction, stop and forward movement of the vehicle. More particularly, the control unit 140 functions to control the vehicle so that the vehicle is correctly parked based on the predetermined points, that is, the start point, the cross point, the base point and the destination point. In this case, the automatic parking of the vehicle is performed through the comparison between the points based on a predetermined threshold because it is practically difficult for the vehicle to be precisely stopped at the locations of the points.

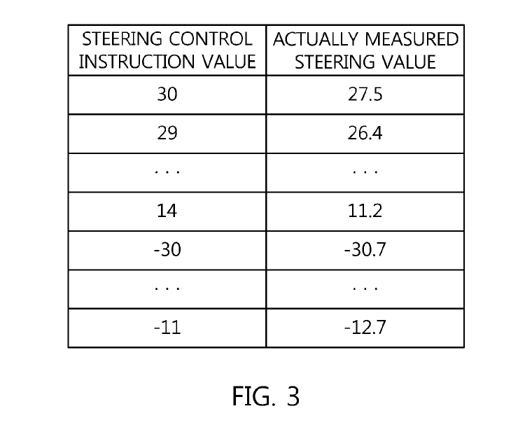

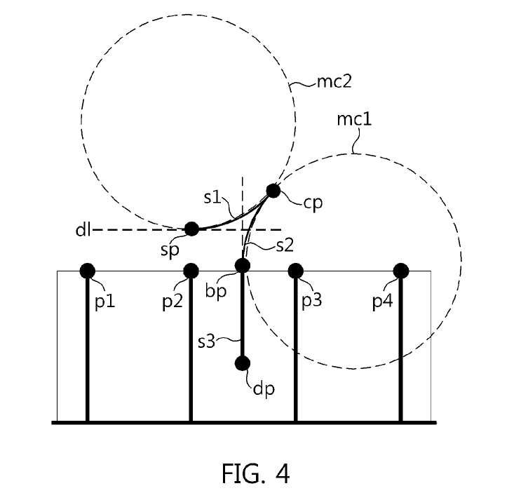

In general, if the control unit 140 instructs the vehicle to be steered over a predetermined angle, for example, +20° for automatic parking, the steering of the vehicle is mechanically implemented by measuring only one of a left wheel and a right wheel. The result value of such steering control includes an error. That is, although the control instruction is executed with respect to an angle of +20°, the wheel of the vehicle may be actually rotated only by an angle of +18°. The control unit 140 corrects the error using a steering error table stored in the parking map storage unit 150, and moves the vehicle so that the vehicle is more precisely parked. A method of generating a steering error table is described in more detail later with reference to FIGS. 2 and 3. Furthermore, it is to be understood that in the notation of the angle, ‘+’ may indicate the right direction, ‘−’ may indicate the left direction and the directions may be reversed.

As described above, the control unit 140 performs automatic parking based on the sublines included in the automatic parking path. In this case, the termination conditions of each subline may basically include a location, heading, and a movement distance as follows.

First, in the case of the location, that is, a first termination condition, the first termination condition may be satisfied if it is determined that a vehicle is placed within a predetermined threshold through the continuous comparison between an end point and the predetermined threshold.

In the case of the heading, that is, a second termination condition, the second termination condition may be satisfied if it is determined that a heading value falls within a heading threshold at an end point through the comparison between the heading value and the heading threshold in the state in which the heading threshold has been previously provided.

In the case of the movement distance, that is, a third termination condition, the third termination condition may be satisfied if it is determined that a movement distance value falls within the threshold of the distance from the start point to the end point through the comparison between the movement distance value and the distance threshold in the state in which the distance threshold has been set. In this case, there is a need for a vehicle sensor capable of measuring the distance. Furthermore, it may be determined that one or more termination conditions are satisfied if the one or more of the termination conditions are satisfied at the same time.

The method of generating the steering error table used in the automatic parking control apparatus of the present invention is described below with reference to FIGS. 2 and 3. FIG. 2 illustrates an example of the method of generating the steering error table using the automatic parking control apparatus according to an embodiment of the present invention, and FIG. 3 illustrates actual steering angles in the example of FIG. 2.

As described above, in the conventional control of a vehicle, an error is inevitably generated because data is input with only one of a left wheel 21 and a right wheel 22 taken into consideration. In order to avoid such an error, in the present invention, the steering of a vehicle is controlled by taking both the two wheels 21 and 22 into consideration. First, the steering angle θₛₜₑₑᵣ of the vehicle may be represented by the following Equation 1:

$${θ}_{steer} = \frac{{θ}_{l} + {θ}_{r}}{2} \qquad ( 1 )$$

In Equation 1, θₛₜₑₑᵣ is the steering angle of the vehicle, θₗ is the steering angle of only the left wheel 21, and θᵣ is the steering angle of only the right wheel 22. If the steering angle θₛₜₑₑᵣ of the vehicle is given in Equation 1, the radius of rotation R of the vehicle 20 may be calculated using the following Equation 2:

$$R = \frac{wheelbase}{tan {θ}_{steering}} \qquad ( 2 )$$

In Equation 2, R is the radius of rotation of the vehicle 20, and wheelbase is the wheel base 26 of the vehicle. That is, the wheel base 26 indicates the distance between the front and rear wheel axles of the vehicle. In contrast, if the radius of rotation R of the vehicle is given in advance, the steering angle may be calculated using the following Equation 3:

$${θ}_{steer} = a tan ( \frac{wheelbase}{R} ) \qquad ( 3 )$$

As described above, an actual rotation value according to a steering instruction value needs to be measured using Equations 1 to 3. That is, a method of setting a steering control value, recording the continuous values of log values (x, y) corresponding to the rotation driving of the vehicle, and measuring an actual steering value according to a steering instruction value may be used. In this case, the actual steering value may be measured using a method of extracting three points from a geometrical circle generated when the vehicle performs rotation driving and then computing a circumscribed circle or a method of obtaining a circle using a Ransac algorithm. The steering error table, such as that illustrated in FIG. 3, may be generated through such experiments. Accordingly, the vehicle can be automatically parked more precisely by correcting a steering control instruction value based on an actually measured steering value using such a steering error table. Furthermore, the steering error table may be stored in the parking map storage unit 150 of FIG. 1 or an external depository, and may be then used by the control unit 140.

An embodiment of a parking method using the automatic parking control apparatus of the present invention is described below with reference to FIG. 4. FIG. 4 is a diagram illustrating an example of a method of the reverse right-angle parking of a vehicle using the automatic parking control apparatus of the present invention. In FIGS. 4, p1 to p4 indicates points at the ends of the sides of parking slots. In the present embodiment, it is assumed that a vehicle is to be parked at a parking slot formed between the points p2 and p3. Furthermore, it is to be understood that information about the points p1 to p4 and information about the entry of the vehicle into the parking slot are basically included in the parking map.

As described above in conjunction with FIG. 1, in order for a vehicle to be parked at a selected parking slot, a base point and a destination point need to be computed first. As described above, the base point is a point at which the vehicle is parallel to both sides of the selected parking slot when the vehicle enters the selected parking slot, and the destination point is a point at which the automatic parking of the vehicle is completed. The base point and the destination point may be previously included in the parking map. If the base point and the destination point are not included in the parking map, the base point and the destination point may be obtained through a separate computation process.

After the base point and the destination point have been computed as described above, the processing unit 130 of the automatic parking control apparatus computes a start point and a cross point using the base point. A process of computing the start point and the cross point is as follows.

First, the processing unit 130 starts from the base point, and computes a first minimum radius circle mc1 formed based on the maximum steering angle of the vehicle. Thereafter, the processing unit 130 computes a drive line d1 that is parallel to the tops of the parking slots and is the expected entry line of the vehicle. The drive line d1 may be spaced apart from the parking slot in a variable manner by taking the size or width of the vehicle and the parking slot into consideration. Thereafter, the processing unit 130 computes a second minimum radius circle mc2 that meets the drive line d1 at one point and comes into contact with the first minimum radius circle mc1. In this case, the second minimum radius circle mc2 is also a circle that may be formed based on the maximum steering angle of the vehicle. In this case, a point at which the second minimum radius circle mc2 meets the drive line d1 is a start point sp. Furthermore, a point at which the first minimum radius circle mc1 meets the second minimum radius circle mc2 is a cross point cp. As described above, the start point sp is a first point from which the vehicle starts automatic parking, and the cross point cp is a point at which the vehicle stops in order to change its moving direction to switch between forward driving and reverse driving after starting from the start point sp.

Once the start point sp, the cross point cp, the base point bp and a destination point dp have been computed as described above, the processing unit 130 may establish an automatic parking path by connecting the points. That is, in the present embodiment, the automatic parking path may include three sublines. The first subline s1 is a path that connects the start point sp and the cross point cp along the path of the second minimum radius circle mc2. The second subline s2 is a path that connects the cross point cp and the base point bp along the path of the first minimum radius circle mc1. The third subline s3 is a path that connects the base point bp and the destination point dp.

The control unit 140 of the automatic parking control apparatus of the present invention may control the vehicle so that it is automatically parked along the first subline s1, the second subline s2 and the third subline s3. More particularly, the vehicle moves forward around a minus maximum steering angle along the first subline s1, moves backward around a plus maximum steering angle along the second subline s2, and moves backward at a steering angle of 0 degree along the third subline s3. In this case, the control unit 140 controls the vehicle so that it proceeds to the points, that is, the start point sp, the cross point cp, the base point bp and the destination point dp. However, the control unit 140 performs the automatic parking of the vehicle through the comparison between the points based on a predetermined threshold because it is practically difficult for the vehicle to be precisely stopped at the start point sp, the cross point cp, the base point bp and the destination point dp. That is, when the vehicle is stopped, the start point sp, the cross point cp, the base point bp and the destination point dp are compared with the stop point based on the predetermined threshold. If the distance between each of the points and the stop point falls within the predetermined threshold, the control unit 140 may permit the vehicle to proceed to a subsequent subline.

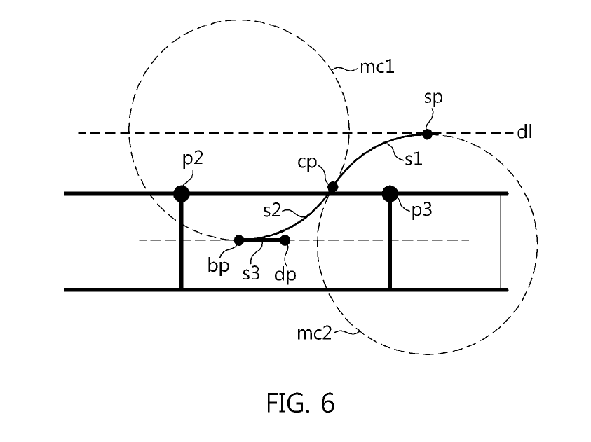

A method of the forward right-angle parking of a vehicle using the automatic parking control apparatus of the present invention is described below with reference to FIG. 5. FIG. 5 is a diagram illustrating an example of the method of the forward right-angle parking of a vehicle using the automatic parking control apparatus of the present invention. The method of the forward right-angle parking of a vehicle is similar to the reverse right-angle parking method described in conjunction with FIG. 4. Accordingly, it is to be understood that redundant descriptions are omitted for clarity of description.

Even in the present embodiment, it is assumed that a vehicle is to be automatically parked at a selected parking slot formed between points p2 and p3. Furthermore, as in the reverse right-angle parking method of FIG. 4, in order to control the automatic parking of the vehicle, a base point bp and a destination point dp need to be computed first. Thereafter, the processing unit 130 computes a start point sp and a cross point cp using the base point bp. Since a process of computing the start point bp and the cross point cp has already been described in conjunction with FIG. 4, a description thereof is omitted for clarity of description. However, the forward right-angle parking method is different from the reverse right-angle parking method in that a first minimum radius circle mc1 is described on the left side of the base point bp, not on the right side thereof. Once the start point sp, the cross point cp, the base point bp and the destination point cp have been computed as described above, the processing unit 130 may establish an automatic parking path that connects the start point sp, the cross point cp, the base point bp and the destination point cp. That is, the automatic parking path may include three sublines like in the embodiment of FIG. 4. The first subline s1 is a path that connects the start point sp and the cross point cp along the path of a second minimum radius circle mc2. The second subline s2 is a path that connects the cross point cp and the base point bp along the path of the first minimum radius circle mc1. The third subline s3 is a path that connects the base point bp and the destination point dp.

The control unit 140 of the automatic parking control apparatus of the present invention may control the vehicle so that it is automatically parked along the first subline s1, the second subline s2 and the third subline s3. More particularly, the vehicle moves forward around a minus maximum steering angle along the first subline s1, moves forward around a plus maximum steering angle along the second subline s2, and moves forward at a steering angle of 0 degree along the third subline s3. In this case, the control unit 140 controls the vehicle so that it proceeds to the points, that is, the start point sp, the cross point cp, the base point bp and the destination point dp. Furthermore, as in the reverse right-angle parking method, in the forward right-angle parking, it is practically difficult for the vehicle to be precisely stopped at the start point sp, the cross point cp, the base point bp and the destination point dp. For this reason, as described in conjunction with FIG. 4, the control unit 140 may perform the automatic parking of the vehicle through the comparison between the start point sp, the cross point cp, the base point bp and the destination point dp based on a predetermined threshold.

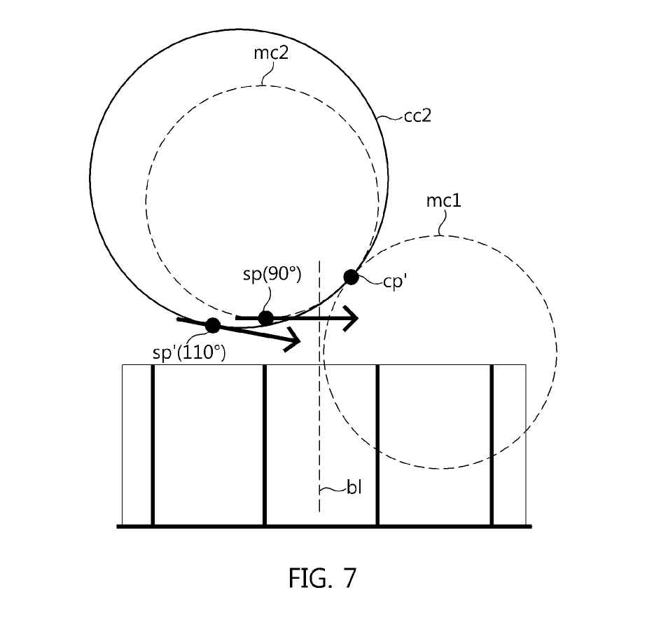

A method of the parallel parking of a vehicle using the automatic parking control apparatus of the present invention is described below with reference to FIG. 6.

FIG. 6 is a diagram illustrating an example of the method of the parallel parking of a vehicle using the automatic parking control apparatus of the present invention. The method of the parallel parking of a vehicle described in conjunction with FIG. 6 is also similar to the method of reverse right-angle parking of a vehicle and the method of the forward right-angle parking of a vehicle described in conjunction with FIGS. 4 and 5. Accordingly, it is to be understood that redundant descriptions are omitted for clarity of description.

As illustrated in FIG. 6, the processing unit 130 may compute a start point sp and a cross point cp using a base point bp. Since a process of computing the start point bp and the cross point cp has already been described in conjunction with FIG. 4, a description thereof is omitted for clarity of description. Once the start point sp, the cross point cp, the base point bp and a destination point cp have been computed as described above, the processing unit 130 may establish an automatic parking path that connects the start point sp, the cross point cp, the base point bp and the destination point cp. That is, as in the embodiment of FIG. 4, the automatic parking path may include three sublines. The first subline s1 is a path that connects the start point sp and the cross point cp along the path of a second minimum radius circle mc2. The second subline s2 is a path that connects the cross point cp and the base point bp along the path of a first minimum radius circle mc1. The third subline s3 is a path that connects the base point bp and the destination point dp.

The control unit 140 of the automatic parking control apparatus of the present invention may control the vehicle so that it is automatically parked along the first subline s1, the second subline s2 and the third subline s3. More particularly, the vehicle moves backward around a plus maximum steering angle along the first subline s1, moves backward around a minus maximum steering angle along the second subline s2, and moves forward around a steering angle of 90 degrees along the third subline s3. In this case, the control unit 140 controls the vehicle so that it proceeds to the points, that is, the start point sp, the cross point cp, the base point bp and the destination point dp. Furthermore, as in the reverse right-angle parking method and the forward right-angle parking method, in the parallel parking method, it is practically difficult for the vehicle to be precisely stopped at the start point sp, the cross point cp, the base point bp and the destination point dp. Accordingly, as described in conjunction with FIG. 4, the control unit 140 may perform the automatic parking of the vehicle through the comparison between the start point sp, the cross point cp, the base point bp and the destination point dp based on a predetermined threshold.

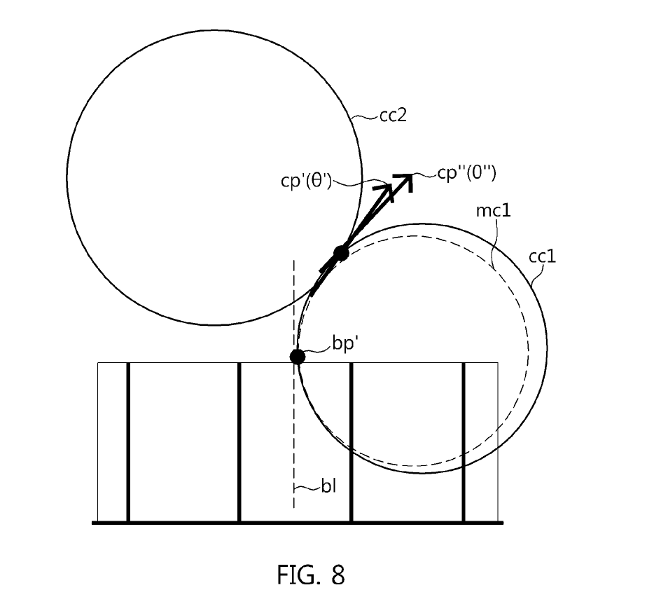

Embodiments in which a subline is corrected using a corrected circle in connection with the example of the reverse right-angle parking method of FIG. 4 are described below with reference to FIGS. 7 and 8. FIGS. 7 and 8 are diagrams illustrating examples in which a subline is corrected using a corrected circle in connection with the example of the reverse right-angle parking method of FIG. 4. As described above, when a vehicle is automatically parked, it is practically difficult for the vehicle to be precisely stopped at the start point sp, the cross point cp, the base point bp and the destination point dp. Furthermore, if the difference in the distance between a stop point, the start point sp, the cross point cp, the base point bp and the destination point dp is present, the automatic parking path of the vehicle also needs to be corrected by taking the difference into consideration. Accordingly, FIGS. 7 and 8 illustrate methods of correcting such an automatic parking path using a corrected circle.

FIG. 7 illustrates an example in which a vehicle is stopped at a second start point sp′ having a heading angle of 110°, not at a first start point sp having a heading angle of 90°. When the vehicle is precisely stopped at the first start point sp, automatic parking may be correctly performed as the vehicle proceeds along set sublines. If the vehicle is stopped at the second start point sp′, existing sublines may not be used. That is, it is necessary to correct steering angles and sublines because it is difficult for a vehicle to be parked at a desired parking slot due to an error problem.

In this case, the processing unit 130 may compute a second corrected circle cc2 that is vertical to a heading of 110° while passing through the second start point sp′ and meets with a first minimum radius circle mc1 at one point. Once the second corrected circle cc2 has been computed, a driving control value may be calculated and a steering control value may be also calculated using the steering error table described in conjunction with FIG. 1. Once the second corrected circle cc2 has been computed as described above, the control unit 140 may form a first correction subline that connects the second start point sp′ and a first corrected cross point cp′ along the path of the second corrected circle cc2 through the processing unit 130. Once the first correction subline has been formed as described above, the control unit 140 may move the vehicle along the first correction subline.

FIG. 8 illustrates an example in which a vehicle is stopped at a second corrected cross point cp″, not at a first corrected cross point cp′. As in the example of FIG. 7, when the vehicle precisely is stopped at the first corrected cross point cp′, automatic parking may be correctly performed as the vehicle proceeds along set sublines. If the vehicle is stopped at the second corrected cross point cp″, existing sublines may not be used. That is, it is necessary to correct steering angles and sublines because it is difficult for a vehicle to be parked at a desired parking slot due to an error problem.

As in the example of FIG. 7, a first dynamic corrected circle cc1 may be computed using a base line b1 and the second corrected cross point cp″. A steering control value and a driving control value may be calculated using the first dynamic corrected circle cc1. When the first dynamic corrected circle cc1 is computed as described above, the control unit 140 may form a second correction subline that connects the second corrected cross point cp″ and a base point bp′ along the path of the first dynamic corrected circle cc1 through the processing unit 130. Once the second correction subline has been formed as described above, the control unit 140 may control the vehicle so that it moves along the second correction subline.

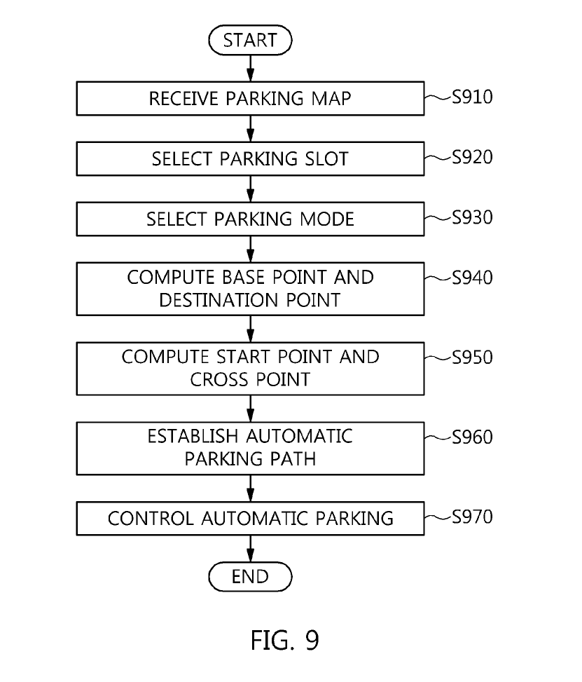

An automatic parking control method according to an embodiment of the present invention is described below with reference to FIG. 9. FIG. 9 is a flowchart illustrating the automatic parking control method according to an embodiment of the present invention. In the following description, it is to be understood that descriptions given in conjunction with FIG. 1 are omitted for clarity of description.

First, the parking map reception unit 110 receives a parking map at step S910. For this purpose, at step S910, the location and heading angle of a vehicle are obtained using a location measurement device, such as a GPS, and the parking map corresponding to the location of the vehicle is received.

At step S920, the selection unit 120 selects a parking slot within the parking map received at step S910. The selection of the parking slot at step S920 may be performed in response to a driver's selection, or may be performed by selecting an empty parking slot from along parking slots within the parking map, as described in conjunction with FIG. 1.

Thereafter, the selection unit 120 selects a parking mode at step S930. In this case, as at step S920, a parking mode may be selected in response to a driver's selection, or may be selected automatically.

At step S940, the processing unit 130 computes a base point at which the vehicle is parallel to both sides of the selected parking slot when the vehicle enters the selected parking slot in a parking mode selected at step S920 and a destination point at which the parking of the vehicle is completed. The base point and the destination point may be basically present in the parking map. If the base point and the destination point are not present in the parking map, however, the base point and the destination point may be obtained through a separate computation process described at step S940.

At step S950, the processing unit 130 computes a start point and a cross point based on the base point computed at step S920. Since a method of computing the start point and the cross point has been described in detail with reference to FIG. 4, a description thereof is omitted for clarity of description.

At step S960, the processing unit 130 establishes an automatic parking path including a plurality of sublines using the start point, the cross point, the base point and the destination point.

At step S970, the control unit 140 controls the automatic parking of the vehicle so that the vehicle is parked along the automatic parking path. That is, at step S970, the control unit 140 functions to control the vehicle so that the vehicle is correctly parked by controlling the steering angle, gear shifting, moving direction, stopping and movement of the vehicle. Furthermore, as described above, in this case, the control unit 140 controls the automatic parking of the vehicle through the comparison based on a predetermined threshold because it is practically difficult for the vehicle to be precisely stopped at the points.

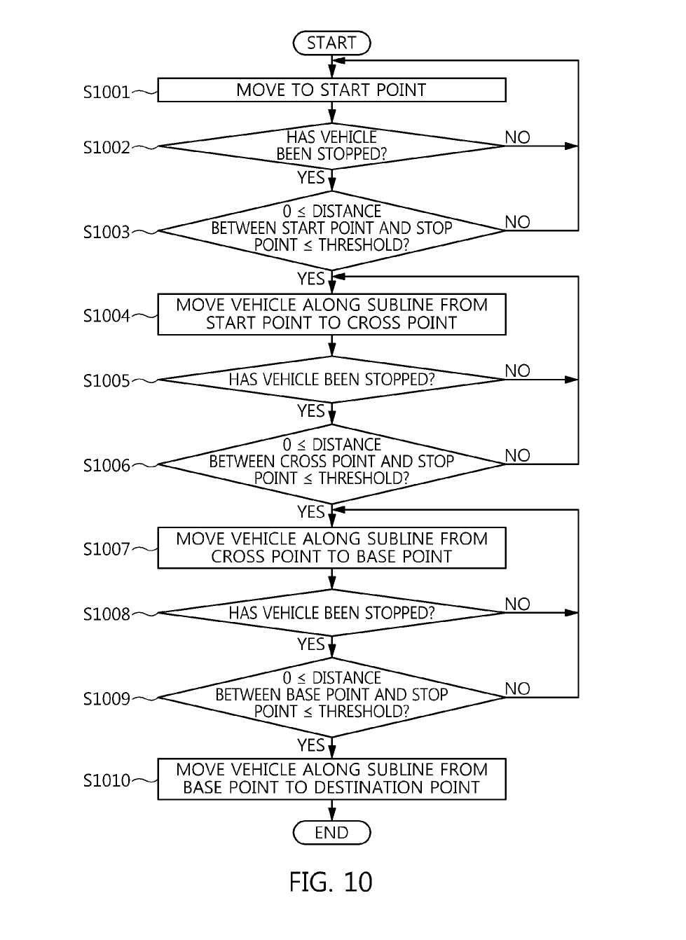

The step of controlling automatic parking that is included in the automatic parking control method of the present invention is described in more detail below with reference to FIG. 10. FIG. 10 is a detailed flowchart illustrating the step of controlling automatic parking that is included in the automatic parking control method of the present invention.

First, at step S1001, the vehicle moves to the start point. At step S1001, the control unit 140 controls the vehicle so that the vehicle is automatically moved to the start point. Alternatively, a driver may directly drive the vehicle to the start point.

Thereafter, at step S1002, whether or not the vehicle has been stopped is determined If, as a result of the determination, it is determined that the vehicle has been stopped, control proceeds to step S1003. If, as a result of the determination at step S1001, it is determined that the vehicle has not been stopped, control proceeds to step S1001 at which the vehicle is moved.

At step S1003, whether or not the distance between the start and stop locations of the vehicle falls within a predetermined threshold is determined That is, at step S1003, whether or not to move the vehicle to a subsequent subline is determined If, as a result of the determination at step S1003, it is determined that the distance between the start point and the stop location of the vehicle falls within the predetermined threshold, control proceeds to step S1004. If, as a result of the determination at step S1003, it is determined that the distance between the start point and the stop location of the vehicle does not fall within the predetermined threshold, control proceeds to step S1001 at which the vehicle is further moved.

At step S1004, the vehicle is moved along a subline from the start point to the cross point.

Thereafter, whether or not the vehicle has been stopped is determined at step S1005. If, as a result of the determination at step S1005, it is determined that the vehicle has been stopped, control proceeds to step S1006. If, as a result of the determination at step S1005, it is determined that the vehicle has not been stopped, control proceeds to step S1004 in which the vehicle continues to move.

At step S1006, whether or not the distance between the cross point and the stop location of the vehicle falls within the predetermined threshold is determined That is, as at step S1003, at step S1006, whether or not to move the vehicle to a subsequent subline is determined If, as a result of the determination at step S1006, it is determined that the distance between the stop location of the vehicle and the cross point falls within the predetermined threshold, control proceeds to step S1007. If, as a result of the determination at step S1006, it is determined that the distance between the stop location of the vehicle and the cross point does not fall within the predetermined threshold, control proceeds to step S1004 in which the vehicle continues to move.

At step S1007, the vehicle proceeds along the subline from the cross point to the base point.

Thereafter, at step S1008, whether or not the vehicle has been stopped is determined If, as a result of the determination at step S1008, it is determined that the vehicle has been stopped, control proceeds to step S1009. If, as a result of the determination at step S1008, it is determined that the vehicle has not been stopped, control proceeds to step S1007 in which the vehicle continues to move.

At step S1009, whether or not the distance between the stop location of the vehicle and the base point falls within the predetermined threshold is determined. That is, at step S1009, whether or not to move the vehicle to a subsequent subline is determined. If, as a result of the determination at step S1009, it is determined that the distance between the stop location of the vehicle and the base point falls within the predetermined threshold, control proceeds to step S1010. If, as a result of the determination at step S1009, it is determined that the distance between the stop location of the vehicle and the base point does not fall within the predetermined threshold, control proceeds to step S1007 in which the vehicle continues to move.

At step S1010, the vehicle moves along the subline from the base point to the destination point. Once the movement of the vehicle has been completed as described above, control proceeds to a termination block.

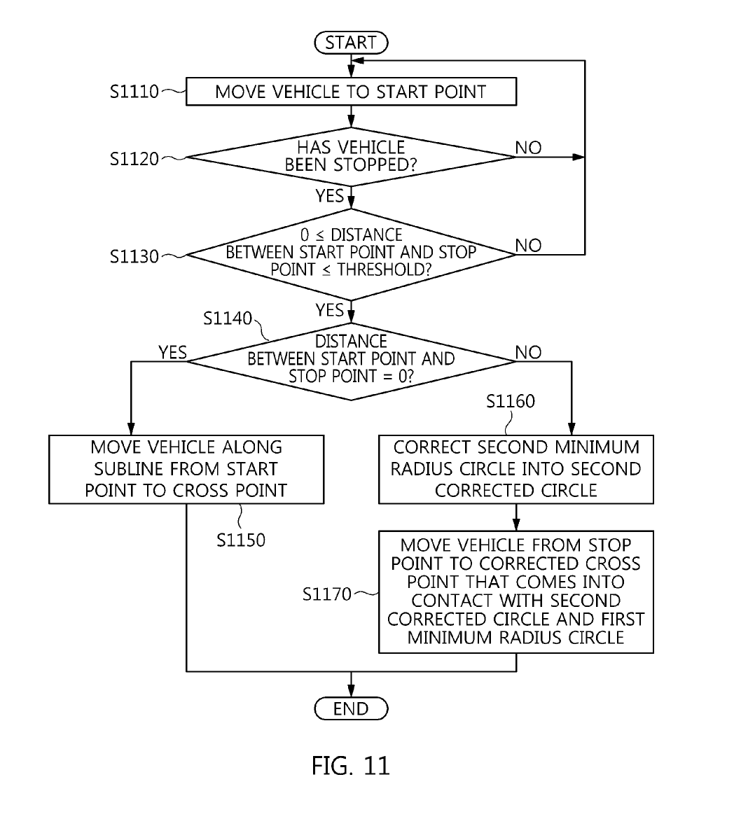

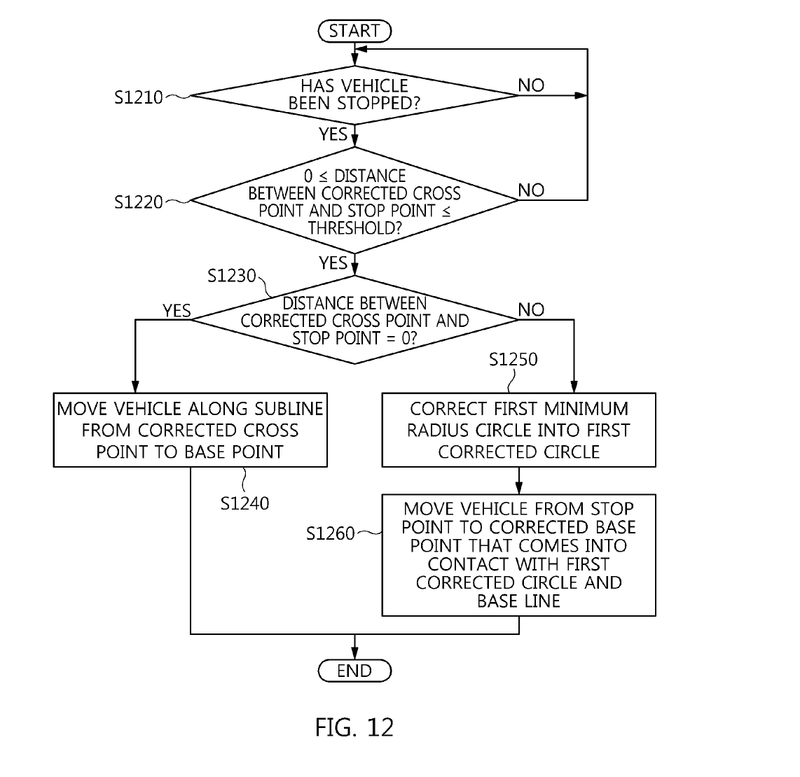

Embodiments in which a subline is corrected using a corrected circle are described below with reference to FIGS. 11 and 12. FIG. 11 is a flowchart illustrating a process of correcting a subline using a corrected circle if necessary through the comparison of the distance between a start point and the stop point of a vehicle.

First, the vehicle is moved to the start point at step S1110. As described in conjunction with FIG. 10, at step S1110, the control unit 140 controls the vehicle so that it automatically moves to the start point. Alternatively, a driver may directly move the vehicle to the start point.

Thereafter, whether or not the vehicle has been stopped is determined at step S1120. If, as a result of the determination at step S1120, it is determined that the vehicle has been stopped, control proceeds to step S1130. If, as a result of the determination at step S1120, it is determined that the vehicle has not been stopped, control proceeds to step S1110 in which the vehicle continues to move.

At step S1130, whether or not the distance between the stop location of the vehicle and the start point falls within a threshold is determined If, as a result of the determination at step S1130, it is determined that the distance between the stop location of the vehicle and the start point falls within the threshold, control proceeds to step S1140. If, as a result of the determination at step S1130, it is determined that the distance between the stop location of the vehicle and the start point does not fall within the threshold, control proceeds to step S1110 at which the vehicle continues to move until the distance between the start point and the stop location of the vehicle falls within the threshold.

At step S1140, whether or not the stop location of the vehicle is exactly identical to the start point is determined. If, as a result of the determination at step S1140, it is determined that the stop location of the vehicle is exactly identical to the start point, control proceeds to step S1150. If, as a result of the determination at step S1140, it is determined that the stop location of the vehicle is not exactly identical to the start point, control proceeds to step S1160.

At step S1150, the processing unit 130 moves the vehicle along a set subline. That is, at step S1150, the vehicle is moved along a subline computed by the processing unit 130 from the start point to a cross point because the vehicle may be moved to a subline generated using the minimum radius circle described in conjunction with FIG. 4. Thereafter, control proceeds to a termination block.

Step S1160 is performed when the stop location of the vehicle is not exactly identical to the start point although the distance between the start point and the stop location of the vehicle falls within the threshold, as described in conjunction with FIG. 7. That is, at step S1160, a subpath of the vehicle is corrected. That is, the second minimum radius circle is corrected into the second corrected circle. More particularly, at step S1160, the second minimum radius circle is corrected so that it is vertical to the heading angle of the vehicle and comes into contact with the first minimum radius circle.

Thereafter, at step S1170, the vehicle is moved from the stop point of the vehicle to a corrected cross point at which the second corrected circle comes into contact with the first minimum radius circle. After the vehicle has been moved to the corrected cross point, control proceeds to the termination block.

FIG. 12 is a flowchart illustrating a process of correcting a subline using a corrected circle if necessary through the comparison of the distance between a cross point and the stop point of a vehicle. In the following description, descriptions given in conjunction with FIG. 8 are omitted for clarity of description.

First, whether or not the vehicle has been stopped is determined at step S1210. If, as a result of the determination at step S1210, it is determined that the vehicle has been stopped, control proceeds to step S1220. If, as a result of the determination at step S1210, it is determined that the vehicle has not been stopped, control returns back to step S1210.

At step S1220, whether or not the distance between the stop point of the vehicle and a corrected cross point falls within a threshold is determined If, as a result of the determination at step S1220, it is determined that the distance between the stop point of the vehicle and the corrected cross point falls within the threshold, control proceeds to step S1230. If, as a result of the determination at step S1220, it is determined that the distance between the stop point of the vehicle and the corrected cross point does not fall within the threshold, control returns back step S1210.

At step S1230, whether or not the stop point of the vehicle is exactly identical to the corrected cross point is determined If, as a result of the determination at step S1230, it is determined that the stop point of the vehicle is exactly identical to the corrected cross point, control proceeds to step S1240. If, as a result of the determination at step S1230, it is determined that the stop point of the vehicle is not exactly identical to the corrected cross point, control proceeds to step S1250.

At step S1240, the vehicle is moved along a subline that connects the corrected cross point and a base point. Thereafter, control proceeds to a termination block.

Step S1250 is performed when the stop location of the vehicle is not exactly identical to the corrected cross point although the distance between the stop location of the vehicle and the corrected cross point falls within the threshold. That is, at step S1250, a subpath of the vehicle is corrected. That is, the first minimum radius circle is corrected into the first corrected circle. More particularly, at step S1250, the first minimum radius circle is corrected into the first corrected circle so that the first minimum radius circle is vertical to the heading angle of the vehicle, comes into contact with the second corrected circle, and comes into contact with a base line that connects the base point and a destination point.

At step S1260, the vehicle is moved from the stop point to the corrected base point at which the first corrected circle comes into contact with the base line. Thereafter, control proceeds to the termination block.

As described above, the automatic parking control apparatus and method of the present invention are advantageous in that a vehicle can be automatically parked at a parking slot intended by a driver.

Furthermore, the automatic parking control apparatus and method of the present invention are advantageous in that a vehicle can be automatically parked without requiring a need for the vehicle to be present in both side parking slots and a need for a driver to perform driving, braking and gear shifting.

The teachings of principles of the present invention may be implemented by a combination of hardware and software. Furthermore, the software may be implemented as an application that is actually implemented on a program storage unit. The application may be uploaded to a machine including a specific architecture and executed by the machine. The machine may be implemented a computer platform having hardware, such as on one or more central processing units (CPUs), computer processors, RAM, and input/output (I/O) interfaces. Furthermore, the computer platform may include an operating system and micro instruction code. In this case, a variety of the aforementioned processes and functions may be part of the micro instruction code, part of the application, or a specific combination of them, which may be executed by various processing devices including a CPU. In addition, a variety of other peripheral devices, such as an additional data storage unit and a printer, may be connected to the computer platform.

It is to be understood that actual connections between the system components of the configuration or process function blocks shown in the accompanying drawings may be changed depending on a method of programming the principles of the present invention because some of the system components and some of the methods are implemented in software. If the teachings are given, those skilled in the art may take the implementation examples or constructions of the principles of the present invention and their similar implementation examples or constructions into consideration.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic parking control apparatus, comprising:
a selection unit configured to select a parking slot within a parking map received through a parking map reception unit;
a processing unit configured to compute a base point at which a vehicle is parallel to both sides of the selected parking slot when the vehicle enters the selected parking slot and a destination point at which automatic parking is completed, to compute a start point and a cross point based on the base point, and to establish an automatic parking path including a plurality of sublines using the start point, the cross point, the base point and the destination point; and
a control unit configured to control the automatic parking so that the vehicle is parked along the automatic parking path.

2. The automatic parking control apparatus of claim 1, wherein the processing unit computes a first minimum radius circle based on a maximum steering angle of the vehicle at the base point.

3. The automatic parking control apparatus of claim 2, wherein the processing unit further computes a second minimum radius circle that is parallel to tops of the parking slots, comes into contact with a drive line, that is, an entry line of the vehicle, and the first minimum radius circle, and is formed based on the maximum steering angle of the vehicle.

4. The automatic parking control apparatus of claim 3, wherein:
the start point is a point at which the drive line comes into contact with the second minimum radius circle; and
the cross point is a point at which the first minimum radius circle comes into contact with the second minimum radius circle.

5. The automatic parking control apparatus of claim 4, wherein the control unit starts the automatic parking at a point within a predetermined threshold from the start point.

6. The automatic parking control apparatus of claim 5, wherein the control unit permits the vehicle to move to a subsequent subline if a distance between a last point of one subline and a stop point of the vehicle is equal to or shorter than the predetermined threshold during the automatic parking of the vehicle along to the subline.

7. The automatic parking control apparatus of claim 6, wherein the control unit corrects the second minimum radius circle into a second corrected circle that is vertical to a heading angle of the vehicle and comes into contact with the first minimum radius circle if, when the vehicle is stopped, a distance between the start point and the stop point of the vehicle exceeds zero and is equal to or shorter than the predetermined threshold, and then moves the vehicle from the stop point to a corrected cross point that comes into contact with the second corrected circle and the first minimum radius circle.

8. The automatic parking control apparatus of claim 7, wherein the control unit corrects the first minimum radius circle into a first corrected circle that is vertical to the heading angle of the vehicle, comes into contact with the second corrected circle, and comes into contact with a base line that connects the base point and the destination point if, when the vehicle is stopped, an error in a distance between the corrected cross point and the stop point of the vehicle exceeds zero and is equal to or shorter than the predetermined threshold, and then moves the vehicle from the stop point to a corrected base point that comes into contact with the first corrected circle and the base line.

9. The automatic parking control apparatus of claim 1, wherein the control unit corrects a mechanical error steering angle of the vehicle using a steering error table stored in a parking map storage unit.

10. An automatic parking control method, comprising:
selecting, by a selection unit, a parking slot within a parking map received through a parking map reception unit;
computing, by a processing unit, a base point at which a vehicle is parallel to both sides of the selected parking slot when the vehicle enters the selected parking slot and a destination point at which automatic parking is completed;
computing, by the processing unit, a start point and a cross point based on the base point;
establishing, by the processing unit, an automatic parking path including a plurality of sublines using the start point, the cross point, the base point and the destination point; and
controlling, by a control unit, the automatic parking so that the vehicle is parked along the automatic parking path.

11. The automatic parking control method of claim 10, wherein computing the start point and the cross point comprises computing a first minimum radius circle based on a maximum steering angle of the vehicle at the base point.

12. The automatic parking control method of claim 11, wherein computing the start point and the cross point comprises further computing a second minimum radius circle that is parallel to tops of the parking slots, comes into contact with a drive line, that is, an entry line of the vehicle, and the first minimum radius circle, and is formed based on the maximum steering angle of the vehicle.

13. The automatic parking control method of claim 12, wherein:
the start point is a point at which the drive line comes into contact with the second minimum radius circle; and
the cross point is a point at which the first minimum radius circle comes into contact with the second minimum radius circle.

14. The automatic parking control method of claim 13, wherein controlling the automatic parking comprises starting the automatic parking at a point within a predetermined threshold from the start point.

15. The automatic parking control method of claim 14, wherein controlling the automatic parking comprises permitting the vehicle to move to a subsequent subline when a distance between a last point of one subline and a stop point of the vehicle is equal to or shorter than the predetermined threshold during the automatic parking of the vehicle along the one subline.

16. The automatic parking control method of claim 15, wherein controlling the automatic parking comprises correcting the second minimum radius circle into a second corrected circle that is vertical to a heading angle of the vehicle and comes into contact with the first minimum radius circle if, when the vehicle is stopped, a distance between the start point and the stop point of the vehicle exceeds zero and is equal to or shorter than the predetermined threshold, and then moving the vehicle from the stop point to a corrected cross point that comes into contact with the second corrected circle and the first minimum radius circle.

17. The automatic parking control method of claim 16, wherein controlling the automatic parking comprises correcting the first minimum radius circle into a first corrected circle that is vertical to the heading angle of the vehicle, comes into contact with the second corrected circle, and comes into contact with a base line that connects the base point and the destination point if, when the vehicle is stopped, an error in a distance between the corrected cross point and the stop point of the vehicle exceeds zero and is equal to or shorter than the predetermined threshold, and then moving the vehicle from the stop point to a corrected base point that comes into contact with the first corrected circle and the base line.

18. The automatic parking control method of claim 10, wherein controlling the automatic parking comprises correcting a mechanical error steering angle of the vehicle using a steering error table stored in a parking map storage unit.
